(19) United States
(12) Patent Application Publication
(10) Pub. No.: US 2010/0076589 A1
(43) Pub. Date: Mar. 25, 2010

(54) NUMERICAL CONTROL DEVICE

(75) Inventor: Bi-Hui Hu, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/541,356

(22) Filed: Aug. 14, 2009

(30) Foreign Application Priority Data
Sep. 23, 2008 (CN) 200810304611.X

(51) Int. Cl. G05B 19/402; G05B 19/401

(52) U.S. Cl. 700/192

(57) ABSTRACT

A numerical control device includes a substrate, an adjusting unit, a machine tool, a workpiece holder, a distance measuring component and a control unit. The adjusting unit is movably positioned on the substrate. The machine tool is positioned on one side of the adjusting unit and has a distal end. The workpiece holder is positioned on the substrate and faces the machine tool. The distance measuring component is aligned with the machine tool and the workpiece holder. The control unit is electrically coupled to the distance measuring component and the adjusting unit.

### BACKGROUND

1. Technical Field

The disclosure relates to a numerical control device.

2. Description of Related Art

Nowadays, numerical control devices are widely used to machine various workpieces. In machining a workpiece, pre-aligning a machine tool with the workpiece is an important process. A typical approach to pre-align the machine tool with the workpiece is to move the machine tool to contact the workpiece, so as to determine a coordinate of the workpiece. The coordinates of the workpiece are stored in a computer and regarded as a reference point during the pre-alignment process. However, when machining a new workpiece, the machine tool must be pre-aligned with the new workpiece again. This complicates the machining process and reduces efficiency. In addition, unexpected impact may occur between the machine tool and the workpiece, which damages the workpiece.

Therefore, a new numerical control device is desired to overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of one embodiment of a numerical control device, the numerical control device including a substrate and a controlling unit.

FIG. 2 is another perspective view of the microphone device of FIG. 1, the substrate and the controlling unit being removed.

### DETAILED DESCRIPTION OF THE EMBODIMENTS

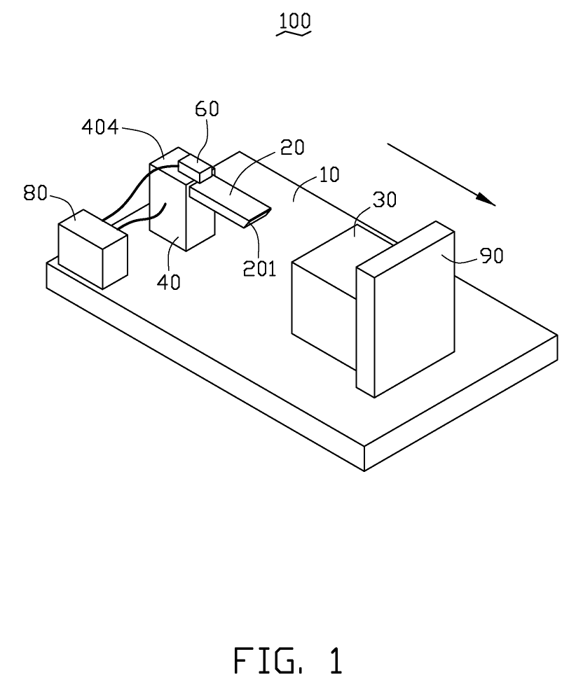

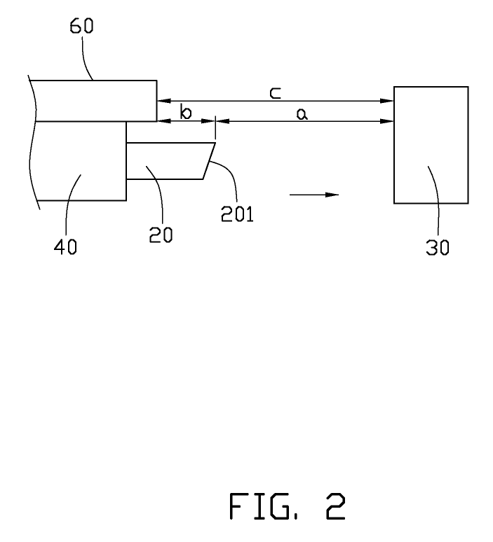

Referring to FIGS. 1 and 2, one embodiment of a numerical control device 100 includes a substrate 10, a machine tool 20, an adjusting unit 40, a distance measuring component 60, a controlling unit 80 and a workpiece holder 90.

The adjusting unit 40 is movably positioned on the substrate 10. The adjusting unit 40 may include a linear driver, such as stepper motor. The machine tool 20 is secured on one side of the adjusting unit 40 and has a distal end 201. The machine tool 20 may be a drill, a saw, a router, or a cutter.

The workpiece holder 90 is positioned on the substrate 10 and faces the machine tool 20. The workpiece holder 90 is configured to hold a workpiece 30, such as computer enclosure, heat sink, mold core and so on.

The distance measuring component 60 is positioned on a top portion 404 of the adjusting unit 40 and spaced apart from the distal end 201. The distance measuring component 60 is aligned with the machine tool 20 and the workpiece holder 90. A distance between the distance measuring component 60 and the distal end 201 is represented as “b”. Measurement of the distance “b” is pre-stored in the controlling unit 80. The distance measuring component 60 is configured to measure a distance “c” between the distance measuring component 60 and the workpiece 30, and send measurement of the distance “c” to the controlling unit 80. In the illustrated embodiment, the distance measuring component 60 is a laser distance measuring component.

The controlling unit 80 is electrically coupled to the distance measuring component 60 and the adjusting unit 40. The controlling unit 80 is configured to calculate a distance “a” between the distal end 201 and the workpiece 30 based on the measurement of the distance “b” and the measurement of the distance “c”, and control the adjusting unit 40 to move the machine tool 20 to contact the workpiece 30.

In use, the workpiece 30 is secured on the workpiece holder 90 and faces the machine tool 20. The distance measuring component 60 measures the distance “c” and sends the measurement of the distance “c” to the controlling unit 80. The controlling unit 80 calculates the distance “a” and controls the adjusting unit 40 to move the machine tool 20 to contact the workpiece 30. The machine tool 20 begins to run, and the adjusting unit 40 moves and adjusts the machine tool 20 to machine the workpiece 30.

The distance “a” can be attained via using the distance measuring component 60 and the controlling unit 80. As a result, the machine tool 20 can be accurately moved to contact the workpiece 30, whereby pre-aligning the machine tool 20 with the workpiece 30 can be omitted.

It is believed that the present embodiments and their advantages will be understood from the foregoing description, and it will be apparent that various changes may be made thereto without departing from the spirit and scope of the embodiments or sacrificing all of its material advantage.

What is claimed is:

1. A numerical control device for machining a workpiece, comprising:
a substrate;
an adjusting unit movably positioned on the substrate;
a machine tool positioned on one side of the adjusting unit and having a distal end;
a workpiece holder positioned on the substrate and facing the machine tool;
a distance measuring component aligned with the machine tool and the workpiece holder and configured to measure a distance “c” between the distance measuring component and the workpiece; and
a control unit electrically coupled to the distance measuring component and the adjusting unit, wherein the control unit is configured to calculate a distance “a” between the distal end and the workpiece based on measurement of the distance “c” received from the distance measuring component and measurement of a distance “b” between the distance measuring component and the distal end, and control the adjusting unit to move the machine tool to contact the workpiece.

2. The numerical control device of claim 1, wherein the measurement of the distance “a” is pre-stored in the control unit.

3. The numerical control device of claim 1, wherein the adjusting unit comprises a linear driver.

4. The numerical control device of claim 1, wherein the machine tool is a drill, a saw, a router, or a cutter.

5. The numerical control device of claim 1, wherein the distance measuring component is positioned on a top portion of the adjusting unit.

6. The numerical control device of claim 1, wherein the distance measuring component is a laser distance measuring component.
